(19) United States
(12) Patent Application Publication
(10) Pub. No.: US 2020/0271085 A1
(43) Pub. Date: Aug. 27, 2020

(54) METHOD AND APPARATUS FOR GENERATING POWER FROM ATMOSPHERIC PRESSURE AND VACUUM

(71) Applicant: WEN-SHOW OU, BELLEVUE, WA (US)

(72) Inventor: WEN-SHOW OU, BELLEVUE, WA (US)

(21) Appl. No.: 16/872,358

(22) Filed: May 11, 2020

Related U.S. Application Data
(63) Continuation-in-part of application No. 16/279,969, filed on Feb. 19, 2019, now abandoned.

(30) Foreign Application Priority Data
Apr. 2, 2018 (TW) 107111545

(51) Int. Cl. F03B 7/00; H02K 7/116; H02K 7/18; F03B 13/10

(52) U.S. Cl. CPC F03B 7/00; F03B 13/10; H02K 7/1823; H02K 7/116

(57) ABSTRACT

A method and apparatus using atmospheric pressure and vacuum force to generate electricity performs coordinated operations of normally open (NO) valves and normally closed (NC) valves to repeatedly push water through an upward pipeline to a first vacuum chamber and let the water flow down by gravity to strike the water wheel of a hydraulic power generator installed in a second vacuum chamber to generate electricity. Specifically, two NC solenoid valves are included to regulate the water flow inside the apparatus, whereas a third NC solenoid valve is included to enable or disable the atmosphere's interaction with the air pressure cylinder of the apparatus in regulating the water flow in each power generation cycle. The method and the apparatus is not affected by local climates or geographical locations and may be installed and applied almost anywhere.

### CROSS REFERENCE TO RELATED APPLICATIONS

This application is a continuation-in-part of U.S. application Ser. No. 16/279,969 filed Feb. 19, 2019, which claims priority of Taiwan Patent Application No. 107111545, filed on Apr. 2, 2018. The entirety of each of said applications is incorporated herein by reference.

### BACKGROUND OF THE INVENTION

### 1. Field of the Invention

This invention relates to a method and apparatus for generating power. More particularly, this invention utilizes atmospheric pressure and vacuum to repeatedly push water upwards through a pipeline to a vacuum chamber and let the water flow downwards to strike and rotate a hydraulic power generator to generate electricity.

### 2. Description of the Related Art

Power mostly comes from burning of petroleum, liquefied gas, coal, woods, etc. Because of carbon dioxide generated from all the burning, the resultant greenhouse effect, climate changes, and other adverse phenomena are increasingly threatening life on earth. As a result, it has become a universal goal for mankind to utilize clean or green energy, such as solar energy, wind power, hydroelectric power, geothermal energy, tidal energy, atmospheric pressure, etc.

Solar energy is of very limited usefulness at nighttime and during cloudy days; wind power is unavailable or unreliable during windless days; reservoir hydroelectric power is unreliable during dry seasons; geothermal energy and tidal energy are certainly confined to particular geographical locations.

In view of the above-mentioned disadvantages and limitations, the inventor undertook an in-depth analysis and research and, having endeavored for a long time and experimented repeatedly, completed the present invention.

### BRIEF SUMMARY OF THE INVENTION

The purpose and objective of this invention is to generate electricity from atmospheric pressure, vacuum and gravity in a cost-efficient way. The invention utilizes atmospheric pressure to push water upwards through a pipeline to reach a vacuum chamber at a height of up to about 10.33 meters, then allows the water in the vacuum chamber to flow downwards by gravity to strike the turbine of a hydraulic power generator to generate electricity. The electricity generation cycle can repeat itself over and again using the apparatus according to the invention.

The apparatus according to the present invention includes a main water tank containing water in communication with the atmosphere; an upward pipeline connecting the main water tank to a first vacuum chamber positioned at a desired height above the main water tank; a second vacuum chamber connected below the first vacuum chamber by a first downward pipeline; an intermediate water tank adjoined to a lower portion of the second vacuum chamber; a second downward pipeline connected to the bottom side of the intermediate water tank; a return pipeline connected between the second downward pipeline and the upward pipeline; and an upward-extending air pressure cylinder connected to a middle side port of the return pipeline.

Furthermore, a power generating assembly including a water wheel, a speed increaser gearbox and a generator is installed inside the second vacuum chamber. The return pipeline is connected to a lower side port of the upward pipeline through a first normally closed (NC) solenoid valve and connected to a lower end of the second downward pipeline through a second NC solenoid valve. The return pipeline has a pair of two adjacent normally open (NO) solenoid valves equipped in a middle portion thereof. The air pressure cylinder has a piston disposed inside and connected to an extension spring and an upper space connected to the atmosphere through a third NC solenoid valve. A water supply valve is disposed at a lower end of the upward pipeline for allowing or stopping water flow from the main water tank.

By properly opening or closing the valves of the apparatus, a continuous closed space including the first vacuum chamber, the second vacuum chamber and the air pressure cylinder may be formed within the apparatus. Then, after a vacuum is created in the continuous closed space, and the water supply valve of the upward pipeline is turned open, the water in the main water tank will flow through the upward pipeline to the first vacuum chamber, then downward to the second vacuum chamber through a nozzle of the first downward pipeline, such that the water will strike the water wheel of the power generating assembly inside the second vacuum chamber to generate electricity. Afterwards, the water will be directed by time-controlled opening and closing operations of the NC solenoid valves and the NO solenoid valves to again flow through the upward pipeline to the first vacuum chamber and the second vacuum chamber in repetitive cycles of power generation.

By adding one or more height elevating assemblies between the upward pipeline and the first vacuum chamber in the apparatus, the first vacuum tank can be raised to essentially any desired altitude, thereby increasing the impact force of the down-flowing water on the water wheel for higher power generation.

Such apparatus can run 24 hours a day, 7 days a week. It can be installed in the backyard of a house or in a factory, regardless of whether it is in a frigid zone, temperate zone, or torrid zone. It generates electricity at low cost without any use of fossil fuel.

In order to make the purpose, effects and characteristics of this invention understood more specifically, preferred embodiments are illustrated below, accompanied by illustrative drawings.

### BRIEF DESCRIPTION OF THE DRAWINGS

FIG. 1 is a sketch showing the components of the apparatus utilizing atmospheric pressure and vacuum to generate electricity according to a first preferred embodiment of the present invention.

FIG. 2 is a sketch illustrating the apparatus with raised pressure differential for generating electricity according to a second preferred embodiment of the present invention.

FIG. 3 illustrates the method using the apparatus for generating electricity according to the present invention, showing the piston having been pushed down in the air pressure cylinder to drive water out of the air pressure cylinder into the return pipeline.

FIG. 4 illustrates the method using the apparatus for generating electricity according to the present invention, showing the piston having been pushed up and restored to its unextended state in the air pressure cylinder.

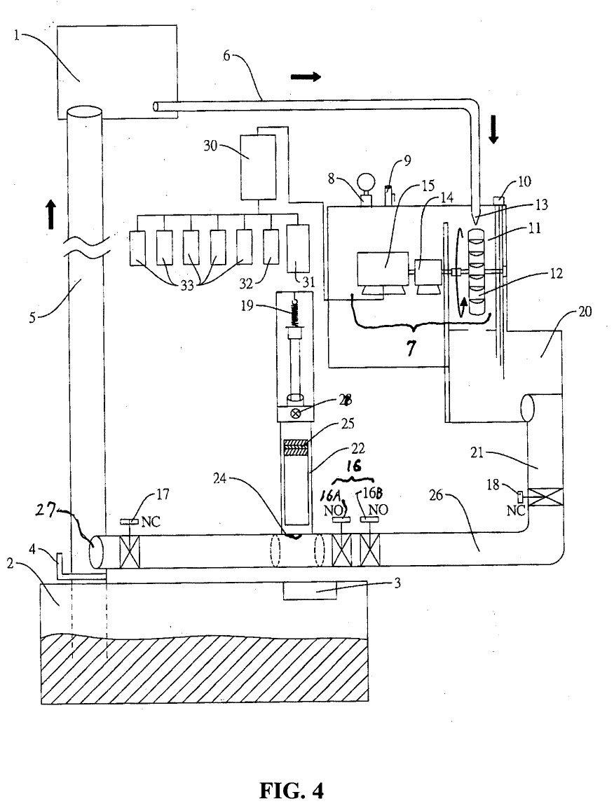

### DETAILED DESCRIPTION OF THE INVENTION

The apparatus and the method for generating electricity utilizing atmospheric pressure and vacuum is illustrated by the preferred embodiments described below in conjunction with the accompanying drawings.

### Embodiment I

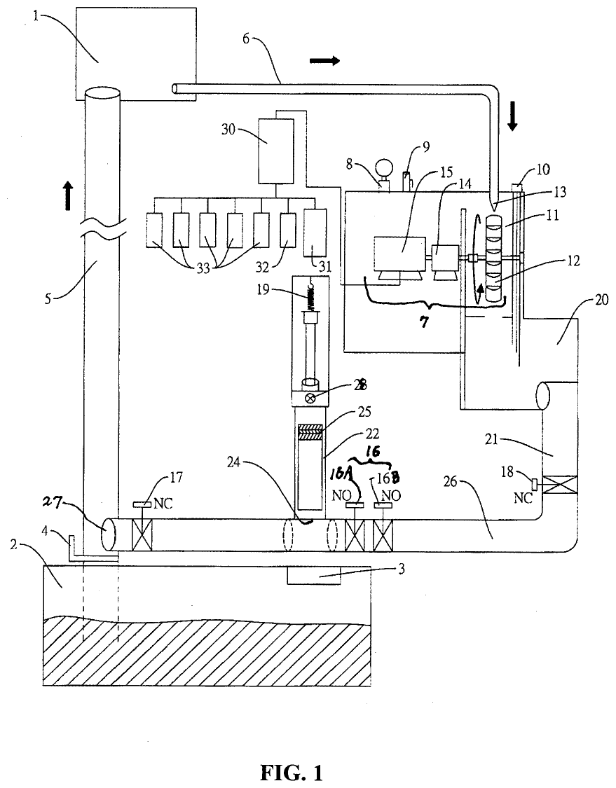

A first embodiment of the apparatus and method for generating electricity using atmospheric pressure and vacuum (and gravity) according to the present invention is illustrated in FIG. 1. The apparatus includes: a main water tank 2 containing water in communication with the atmosphere via an opening 3; a first vacuum chamber 1 positioned at a height (of up to 10.33 meter) above the level of water in the main water tank 2; an upward pipeline 5 connecting the main water tank 2 to the first vacuum chamber 1; a second vacuum chamber 11 positioned below the first vacuum chamber 1 and above the main water tank 2; a first downward pipeline 6 connecting the first vacuum chamber 1 to the second vacuum chamber 11; a power generating assembly 7 disposed inside the second vacuum chamber 11; an intermediate water tank 20 adjoined to a lower portion of the second vacuum chamber 11 and in fluid communication with the second vacuum chamber 11; a second downward pipeline 21 with an upper end connected to the bottom side of the intermediate water tank 20; a return pipeline 26 connected between a lower end of the second downward pipeline 21 and a lower side port 27 of the upward pipeline 5; and an air pressure cylinder 22 with a piston 25 therein and vertically connected from above to a middle side port 24 of the return pipeline 26.

Furthermore, as shown in FIG. 1, the upward pipeline 5 is equipped with a water supply valve (e.g. a manual stopcock valve) 4 for blocking or admitting the water flow from the main water tank 2 into the upward pipeline 5. The water supply valve 4 is positioned lower than the lower side port 27 of the upward pipeline 5. The lower end of the first downward pipeline 6 is formed as or fitted with a nozzle 13 for forming a jet stream from the water following through the first downward pipeline 6.

The return pipeline 26 is connected to the lower side port 27 of the upward pipeline 5 through a first normally closed (NC) solenoid valve 17 and is connected to the lower end of the second downward pipeline 21 through a second NC solenoid valve 18. It is noted that each of the two NC solenoid valves 17,18 is open when energized (by electricity supplied thereto), but closed when de-energized. Except for a section connected to the second downward pipeline 21, the return pipeline 26 is substantially horizontal at the level of the lower side port 27 of the upward pipeline 5. Therefore, the second vacuum chamber 11 and the adjoining intermediate water tank 20 are both at a level above the return pipeline 26. The return pipeline 26 is further equipped with a pair of two adjacent normally open (NO) solenoid valves 16A,16B between the middle side port 24 and the second NC solenoid valve 18 at a location near the middle side port 24. Specifically, the first NO solenoid valve 16A is positioned closer to the middle side port 24 than the second NO solenoid valve 16B. It is noted that each of the two NO solenoid valves 16A,16B is closed when energized (by electricity supplied thereto), but open when de-energized. In this embodiment of the present invention, the two NO solenoid valves 16A,16B are open or closed at the same time. Therefore, each one may be considered as a backup for the other; or the two may be treated as one NO solenoid valve 16, as in the following description.

Moreover, in this embodiment, whenever the NO solenoid valve 16 (16A/16B) is open, the first NC solenoid valve 17 is closed, and vice versa, so the operations (i.e. opening or closing) of the first NC solenoid valve 17 and the NO solenoid valve 16 (16A/16B) may be controlled as a group by one timer-controller (not shown), whereas the operations of the second NC solenoid valve 18 may be controlled by another timer-controller (not shown).

The second vacuum chamber 11 is equipped with a vacuum valve 9 (through which air may be drawn out to create vacuum), a vacuum pressure gauge 8, and a liquid level probe 10 extending through the second vacuum chamber 11 and into the intermediate water tank 20. The power generating assembly 7 includes a water wheel (or turbine) 12 located in a position corresponding to the nozzle 13 of the first downward pipeline 6, a speed increaser gearbox 14 connected to the water wheel (or turbine) 12, and a generator 15 connected to the speed increaser gearbox 14. When the water wheel 12 is struck and turned by the water stream flowing down through the nozzle 13, it rotates the speed increaser gearbox 14 and the generator 15 to generate electricity. Generally, the generator 15 includes a stator and a rotor (not shown). Since the components and operational principle of the power generating assembly 7 are well known in the art, they will not be further described. Suffice to say that a sufficient height differential should be maintained between the first vacuum chamber 1 and the second vacuum chamber 11.

For proper operations of the apparatus of the present invention, the intermediate water tank 20 has a storage capacity larger than that of the first vacuum chamber 1. The purpose of the liquid level probe 10 is to keep the water level in the intermediate water tank 20 from getting too high by sending a warning signal or alarm when the water level in the intermediate water tank 20 reaches the lower end of the liquid level probe 10. Suffice to say that the water level in the intermediate water tank 20 is regulated or controlled by a liquid level controller (not shown) in conjunction with the liquid level probe 10.

As further illustrated in FIG. 1, the piston 25 inside the air pressure cylinder 22 is connected to the lower end of an extension spring 19, which is fixed at its upper end to the top inner wall of the air pressure cylinder 22. The internal space of the air pressure cylinder 22 is divided into two by the piston 25: the upper space (on the same side as the extension spring 19) is in air communication with the atmosphere via a third normally closed (NC) solenoid valve 28 (when it is energized to open so as to act as an air hole), and the lower space (under the piston 25) is in fluid communication, through the middle side port 24 of the return pipeline 26, with the return pipeline 26, the second downward pipeline 21 and the intermediate water tank 20 (when the NO solenoid valve 16 and the second NC solenoid valve 18 are open). The operations of the third NC solenoid valve 28 may be controlled by yet another timer-controller (not shown).

As also shown in FIG. 1, the generator 15 is connected by a cable to the main power switch 30, which is connected to sub-power switches 31, 32 and 33. The electricity generated by the generator 15 is transmitted to the main power switch 30 and then distributed to each of the sub-power switches 31, 32 and 33. In this embodiment, the sub-power switches 31 and 33 are used to supply electricity to the power grid or directly to end users; the sub-power switch 32 is connected to the liquid level controller for monitoring/controlling the operations of the liquid level probe 10 and the timer-controllers mentioned above for controlling the operations of the NO solenoid valve 16 (16A/16B) and the NC solenoid valves 17,18,28. It is understood that the timer-controllers may optionally be consolidated into an overall timer-controller (not shown) connected to the sub-power switch 32. Therefore, the overall timer-controller will be considered in the following description of the present invention. Since the components and operational principle of the timer-controller for controlling the operations of NC or NO solenoid valves are generally known in the art, they will not be further described.

With the above-described apparatus, the method according to the present invention for generating electricity using atmospheric pressure and vacuum proceeds as follows:

(A) close the water supply valve 4 of the upward pipeline 5 and open the second NC solenoid valve 18 (using an external power source) while keeping the NO solenoid valve 16 (16A/16B) open so that a continuous closed space is formed in the apparatus, including the upward pipeline 5, the first vacuum chamber 1, the first downward pipeline 6, the second vacuum chamber 11, the intermediate water tank 20, the second downward pipeline 21, the return pipeline 26, and the space under the piston 25 in the air pressure cylinder 22 (with the third NC solenoid valve 28 closed);

(B) connect a vacuum pump (not shown) to the vacuum valve 9 of the second vacuum chamber 11 and operate the vacuum pump to create a vacuum in the second vacuum chamber 11 and throughout the continuous closed space in the apparatus;

(C) close the vacuum valve 9, then open the water supply valve 4 of the upward pipeline 5, upon which water in the main water tank 2, under atmospheric pressure through the opening 3 of the main water tank 2, flows into and fills up the continuous closed space while pushing the piston 25 in the air pressure cylinder 22 upwards, until the water in the intermediate water tank 20 reaches a preset level; in the meantime, water flowing down from the first downward pipeline 6 strikes and turns the water wheel 12 for the generator 15 to start generating electricity;

(D) close the water supply valve 4, and set the apparatus to the auto mode: namely, set the power source for the liquid level controller (with the liquid level probe 10) and the overall timer-controller to the sub-power switch 32, which draws power from the generator 15;

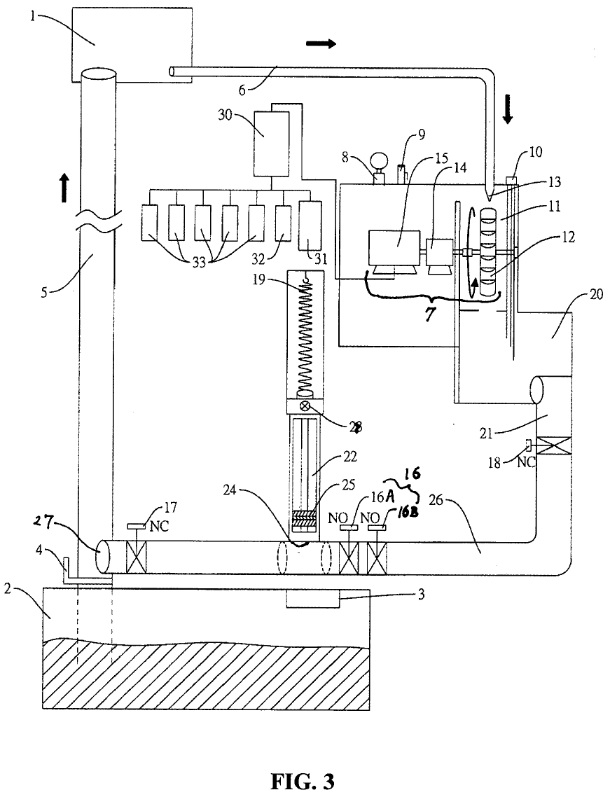

(E) upon entering the auto mode, the apparatus proceeds with the power generation cycle in the following sequence:
(1) Open the first NC solenoid valve 17; close the NO solenoid valve 16 and return the second NC solenoid valve 18 to its closed status; and open the third NC solenoid valve 28. At that instant, air follows through the third NC solenoid valve 28 into the air pressure cylinder 22, pushing down the piston 25 and extending the extension spring 19 (as shown in FIG. 3), driving the water under the piston 25 of the air pressure cylinder 22 to flow out through the middle side port 24 of the return pipeline 26, the first NC solenoid valve 17, the upward pipeline 5, the first vacuum chamber 1, the first downward pipeline 6, and the nozzle 13, striking and turning the water wheel 12 and therefore the generator 15 to generate electricity, as described earlier. FIG. 3 illustrates the piston 25 having been pushed down and the extension spring 19 extended in the air pressure cylinder 22 to drive water out of the air pressure cylinder 22.
(2) After a preset time period T1 (normally about a second), return the third NC solenoid valve 28 to its closed status. Because the extension spring 19 is no longer under the atmospheric pressure through the third NC solenoid valve 28 (in the closed status), the extension spring 19 quickly returns to its unextended state, while starting to carry water up through the middle side port 24 of the return pipeline 26 to enter the space under the piston 25 in the air pressure cylinder 22.
(3) After a short preset time period T2, open the second NC solenoid valve 18 and the NO solenoid valve 16, and return the first NC solenoid valve 17 to its closed status. At that instant, water flows from the intermediate water tank 20 through the second downward pipeline 21 and the second NC solenoid valve 18 into the return pipeline 26 and then through the NO solenoid valve 16 and the middle side port 24 to completely fill up the space under the piston 25 in the air pressure cylinder 22 after the extension spring 19 returns to its unextended state.

(4) Wait for a preset time period T3 to allow step (3) to run its course.

The auto mode described in step (E) will repeat itself over and again.

According to the foregoing description, the method and apparatus according to the present invention can generate electricity in repetitive cycles, 24 hours a day, 7 days a week. The apparatus can be installed in the backyard of a house or in a factory, regardless of the local climatic or weather conditions.

### Embodiment II

When a relatively larger capacity of power generation is demanded, a larger flow rate or a larger impact force is required of the water stream from the nozzle 13 to strike and rotate the water wheel 12. To accomplish this, the height of the first vacuum chamber 1 over the water wheel 12 need be increased to increase the pressure differential, and the upward pipeline 5 and the diameters of the first downward pipeline 6 need be lengthened. Moreover, the various pipelines in the apparatus may have to be larger in diameter.

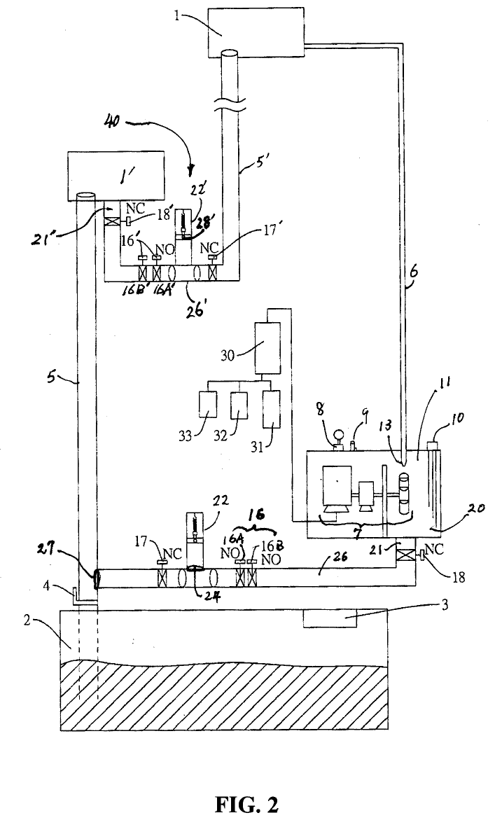

FIG. 2 illustrates a second embodiment of the present invention for this purpose. As shown in FIG. 2, instead of connecting the upward pipeline 5 directly to the first vacuum chamber 1, the upward pipeline 5 is connected to a height elevating assembly 40, which is in turn connected to the first vacuum chamber 1.

The height elevating assembly 40 includes an accessory vacuum chamber 1′, which is connected to the upward pipeline 5 of the apparatus shown in FIG. 1 and to a downward pipeline 21′, a second NC solenoid valve 18′, a return pipeline 26′, a NO solenoid valve 16′ (or a pair of adjacent NO solenoid valves 16A′,16B′), an air pressure cylinder 22′ equipped with a third NC solenoid valve 28′, a first NC solenoid valve 17′, and an upward pipeline 5′ (without a water supply valve), which is connected to the first vacuum chamber 1 of the apparatus shown in FIG. 1. Essentially, the accessory vacuum chamber 1′, the downward pipeline 21′, the second NC solenoid valve 18′, the return pipeline 26′, the NO solenoid valve 16′ (16A′/16B′), the air pressure cylinder 22′, the first NC solenoid valve 17′ and the upward pipeline 5′ in the second embodiment are respectively the same in structure and function as the first vacuum chamber 1, the second downward pipeline 21, the second NC solenoid valve 18, the return pipeline 26, the NO solenoid valve 16′, the air pressure cylinder 22, the first NC solenoid valve 17 and the upward pipeline 5 of the apparatus of the first embodiment described earlier, except that the upper end of the downward pipeline 21′ is connected to the accessory vacuum chamber 1′.

As shown in FIG. 2, the first vacuum chamber 1 in this embodiment is elevated to an altitude higher than is the first vacuum chamber 1 in the embodiment shown in FIG. 1. The upward pipeline 5 and the downward pipeline 6 in this embodiment are extended and elevated higher than their counterparts in FIG. 1. Therefore, the water flowing from the first vacuum chamber 1 through the second pipeline 6 will strike the water wheel 12 with a larger impact force and generating more electricity.

FIG. 2 shows just one height elevating assembly 40, however, more than one height elevating assembly may be provided between the upward pipeline 5 and the first vacuum chamber 1 to increase the height of the first vacuum chamber 1 over the water wheel 12.

### Benefits and Advantages of the Invention

From the foregoing, the method and apparatus for generating electricity according to the present invention has the following advantages:

1. it is not limited by the geographical or climate conditions and is environmentally friendly; the apparatus may be installed in almost all locations for around-the-clock operations.
2. it is easily scalable by adding intermediate height elevating assemblies and/or increasing the diameter of the pipelines to increase the flow rate and impact force of the water to produce more electricity;
3. it consumes little electricity to start its operation and can continue to generate electricity perpetually afterwards.

In the apparatus of the present application, water is used due to its great abundance and wide availability on earth. However, other liquids can certainly be used instead of water. In the embodiments discussed above, the vacuum valve 9 and the vacuum pressure gauge 8 are installed on the second vacuum chamber 11 for creating a vacuum in the apparatus. Nevertheless, the vacuum valve 9 and the vacuum pressure gauge 8 may be disposed on the first vacuum chamber 1 instead of, or in addition to, the second vacuum chamber 11.

Because a prior art search did not find any identical or similar structure existing prior to this application. this invention meets patentability requirements and should be patentable.

The foregoing are merely some preferred embodiments of this invention and should not limit the claims of the present application as a result. Changes of equivalent structures which apply this invention's instructions and claims are all included in the claims of this invention for the same reason.

What is claimed is:

1. An apparatus for generating electricity using atmospheric pressure and vacuum, comprising:
a main water tank containing water in communication with the atmosphere;
a first vacuum chamber positioned at a predetermined height above the main water tank;
an upward pipeline connecting the main water tank to a bottom side of the first vacuum chamber, wherein the upward pipeline is equipped with a water supply valve at a lower end thereof and has a lower side port adjacently above the water supply valve;
a second vacuum chamber at a height lower than the first vacuum chamber and higher than the main water tank, wherein a vacuum valve is disposed on at least one of the second vacuum chamber and the first vacuum chamber for drawing air out to create a vacuum therein;
a first downward pipeline connecting the first vacuum chamber to the second vacuum chamber and having a nozzle fitted at a lower end thereof;
a power generating assembly disposed within the second vacuum chamber;
an intermediate water tank adjoined to a lower portion of the second vacuum chamber and in fluid communication with the second vacuum chamber, wherein the intermediate water tank is equipped with a liquid level probe;
a second downward pipeline having an upper end connected to a bottom side of the intermediate water tank;
a return pipeline having a first end connected to the lower side port of the upward pipeline through a first normally closed (NC) solenoid valve and a second end connected to a lower end of the second downward pipeline through a second NC solenoid valve, wherein a first normally open (NO) solenoid valve is disposed in a middle portion of the return pipeline; and
an air pressure cylinder vertically connected from above to a middle side port of the return pipeline, wherein the NO solenoid valve is located between the middle side port and the second NC solenoid valve, and the air pressure cylinder includes therein a piston, an extension spring, and a third NC solenoid valve connecting between a space above the piston in the air pressure cylinder and the atmosphere, wherein the extension spring has a lower end attached to the piston and an upper end fixed to a top inner wall of the air pressure cylinder, and when the third NC solenoid valve is open the space above the piston in the air pressure cylinder is in air communication with the atmosphere; and
an overall timer-controller electrically connected via a sub-power switch to the power generating assembly for controlling the operations of the NO solenoid valve and the three (the first, the second and the third) NC solenoid valves,
wherein when the water supply valve and the vacuum valve are closed, the NO solenoid valve is open, the first and the third NC solenoid valves are closed and the second NC solenoid valve is open, a continuous closed space is formed within the apparatus, which extends from the upward pipeline, through the first vacuum chamber, the first downward pipeline, the second vacuum chamber, the intermediate water tank, the second downward pipeline, the return pipeline, and a space under the piston in the air pressure cylinder,
whereby after a vacuum is created in the continuous closed space and the water in the main water tank is allowed to enter and propagate through the continuous closed space, the water will flow through the upward pipeline to the first vacuum chamber and into the second vacuum chamber through the nozzle of the first downward pipeline, and then interact with the power generating assembly to generate electricity; afterwards the water will be directed, in an auto mode through coordinated operations of the three NC solenoid valves and the NO solenoid valve and up-and-down movement of the piston along with the extension and retraction of the extension spring, to recycle through the continuous closed space to the second vacuum chamber to interact with the power generating assembly in repetitive cycles of power generation.

2. The apparatus for generating electricity as claimed in claim 1, wherein the vacuum valve is disposed on the second vacuum chamber.

3. The apparatus for generating electricity as claimed in claim 1, wherein the vacuum valve is disposed on the first vacuum chamber.

4. The apparatus for generating electricity as claimed in claim 1, wherein the power generating assembly includes a water wheel corresponding in position to the nozzle of the first downward pipeline, a speed increaser gearbox connected to the water wheel, and a generator connected to the speed increaser gearbox.

5. The apparatus for generating electricity as claimed in claim 1, wherein the overall timer-controller includes a timer-controller for controlling the first NC solenoid valve and the NO solenoid valve as a group.

6. The apparatus for generating electricity as claimed in claim 1, wherein the first vacuum chamber is positioned at a height no more than 10.33 meter above the water level in the main water tank.

7. The apparatus for generating electricity as claimed in claim 1, wherein:
the upward pipeline connects the main water tank to the first vacuum chamber via one or more height elevating assemblies, each height elevating assembly comprising:
an accessory vacuum chamber;
a downward pipeline having an upper end connected to a bottom side of the accessory vacuum chamber;
an upward pipeline;
a return pipeline having a first end connected a lower end of the upward pipeline through a first NC solenoid valve and a second end connected to a lower end of the downward pipeline through a second NC solenoid valve, wherein a NO solenoid valve is disposed in a middle portion of the return pipeline, and
an air pressure cylinder vertically connected from above to a middle side port of the return pipeline, wherein the NO solenoid valve is located between the middle side port and the second NC solenoid valve, and the air pressure cylinder includes therein a piston, an extension spring, and a third NC solenoid valve connecting between a space above the piston in the air pressure cylinder and the atmosphere, wherein the extension spring has a lower end attached to the piston and an upper end fixed to a top inner wall of the air pressure cylinder, and when the third NC solenoid valve is open the space above the piston in the air pressure cylinder is in air communication with the atmosphere,
wherein the bottom side of the accessory vacuum chamber is connected to an upper end of the upward pipeline of a next lower height elevating assembly or, if no lower height elevating assembly is present, to the upward pipeline from the main water tank;
the upward pipeline has an upper end connected to the bottom side of the accessory vacuum chamber of a next higher height elevating assembly or, if no higher height elevating assembly is present, to the bottom side of the first vacuum chamber; and
a timer-controller electrically connected via a sub-power switch to the power generating assembly for controlling the operations of the NO solenoid valve and the three NC solenoid valves of the height elevating assembly,
wherein the continuous closed space further includes internal space of the accessory vacuum chamber, the downward pipeline, the return pipeline, a space under the piston in the air pressure cylinder and the upward pipeline of the height elevating assembly.

8. A method of generating electricity using atmospheric pressure and vacuum, comprising the following steps in such order:
(a) providing an apparatus as claimed in claim 1;
(b) closing the water supply valve of the upward pipeline and opening the second NC solenoid valve while keeping the NO solenoid valve open and the first and the third NC solenoid valves closed so that the continuous closed space is formed in the apparatus;
(c) connecting an external vacuum pump to the vacuum valve and operating the vacuum pump to create a vacuum in the continuous closed space in the apparatus;
(d) closing the vacuum valve, and opening the water supply valve of the upward pipeline, upon which water flows from the main water tank through the water supply valve and propagates through the continuous closed space while pushing upward the piston in the air pressure cylinder, until water in the intermediate water tank reaches a preset level;
(e) closing the water supply valve, and switching the apparatus to an auto mode by setting power source for the liquid level probe and the overall timer-controller to the sub-power switch so that the liquid level probe and the overall timer-controller are powered by the sub-power switch;
(f) performing a power generation cycle by controlling the operations of the three NC solenoid valves and the NO solenoid valve in the following sequence:
(1) opening the first NC solenoid valve and the third NC solenoid valve and closing the second NC solenoid valve and the NO solenoid valve, upon which the piston in the air pressure cylinder is pushed down by the atmospheric pressure through the third NC solenoid valve, and the extension spring is extended to drive the water in the air pressure cylinder out into the return pipeline, through the return pipeline, the upward pipeline, the first vacuum chamber and into the second vacuum chamber to interact with the power generating assembly to generate electricity;
(2) after a time period T1, closing the third NC solenoid valve, upon which the extension spring returns to its unextended state, while starting to carry water up through the middle side port of the return pipeline to enter the space under the piston in the air pressure cylinder;
(3) after a time period T2, opening the second NC solenoid valve and the NO solenoid valve and closing the first NC solenoid valve, upon which water flows from the intermediate water tank through the second downward pipeline and the second NC solenoid valve into the return pipeline and then through the NO solenoid valve and the middle side port to fill up the space under the piston in the air pressure cylinder; and
(4) waiting for a time period T3 for step (3) to finish; and
(g) repeating step (f).

9. The method of generating electricity as claimed in claim 8, wherein the water flows downward from the first vacuum chamber by action of gravity only.

10. The method of generating electricity as claimed in claim 8, wherein the vacuum valve is disposed on the second vacuum chamber.

11. The method of generating electricity as claimed in claim 8, wherein the vacuum valve is disposed on the first vacuum chamber.

12. The method of generating electricity as claimed in claim 8, wherein
the power generating assembly includes a water wheel corresponding in position to the nozzle of the first downward pipeline, a speed increaser gearbox connected to the water wheel, and a generator connected to the speed increaser gearbox, and
the water flowing from the first vacuum chamber and through the nozzle of the first downward pipeline strikes the water wheel to rotate the water wheel along with the generator to generate electricity.

13. The method of generating electricity as claimed in claim 8, wherein the overall timer-controller includes a timer-controller for controlling the first NC solenoid valve and the NO solenoid valve as a group.

14. The method of generating electricity as claimed in claim 8, wherein T1 is about 1 second.

15. The method of generating electricity as claimed in claim 8, wherein the first vacuum chamber is positioned at a height no more than 10.33 meter above the water level in the main water tank.
